(19) United States
(12) Patent Application Publication
(10) Pub. No.: US 2008/0042369 A1
(43) Pub. Date: Feb. 21, 2008

(54) STUFFING BOX WITH WEAR INDICATOR

(76) Inventors: Lee A. Krywitsky, Calgary (CA); Ken Stephenson, Calgary (CA); Carlos Cosse, Calgary (CA); Colin Bielesch, Calgary (CA)

Correspondence Address: WORKMAN NYDEGGER, 60 EAST SOUTH TEMPLE, 1000 EAGLE GATE TOWER, SALT LAKE CITY, UT, 84111, US

(21) Appl. No.: 11/744,783

(22) Filed: May 4, 2007

Related U.S. Application Data
(60) Provisional application No. 60/746,475, filed on May 4, 2006.
(60) Provisional application No. 60/807,330, filed on Jul. 13, 2006.

(51) Int. Cl. F16J 15/18

(52) U.S. Cl. 277/522

(57) ABSTRACT

A stuffing box for sealing around a shaft. The stuffing box includes a seal which engages the circumferential surface of a shaft and creates a fluid seal therearound. The stuffing box also includes a wear indicator that can be used to provide an audible, visual or tactile indication that the seal has deteriorated a predetermined amount. An additional stuffing box is disclosed in which wedge inserts are used to create an effective fluid seal around a shaft. The stuffing box includes lower and upper housings, each including a seal. In each seal, a wedge insert is placed within tapered packing and compresses the packing against a shaft received within the housings, and against an internal surface of the housings. The packings can be placed on a platform ring that uses a spring to exert a biasing force further compressing the packings against the wedge and against the shaft and housing.

### CROSS-REFERENCE TO RELATED APPLICATIONS

This application claims priority to, and the benefit of, U.S. Provisional Patent Application Ser. No. 60/746,475, filed May 4, 2006 and entitled “STUFFING BOX SEAL WITH WEAR INDICATOR”, and U.S. Provisional Patent Application Ser. No. 60/807,330, filed Jul. 13, 2006, and entitled “STUFFING BOX SEAL WITH WEAR INDICATOR”, each of which are incorporated herein by this reference, in their entireties.

### BACKGROUND OF THE INVENTION

1. The Field of the Invention

Exemplary embodiments of the invention relate to fluid seals, and more particularly to fluid seals utilized in connection with a stuffing box. Still more particularly, embodiments of the present invention relate to fluid seals in connection with a stuffing box to seal chambers containing environmentally hazardous fluids and fluids under pressure.

2. The Related Technology

While oil production remains critical to our way of life, greater regulations are being implemented, and improved measures are needed, to ensure that the produced oil does not pollute the environment from which it is extracted. Currently, one of the sources of pollution of toxic fluids is the result of packing seals leaking when attempting to seal a hazardous fluid under pressure. For example, in an exemplary system, a plunger pump is used to transfer, load, circulate liquids, or produce oil wells. In such systems, however, pumps have, at one time or another, had to have the packing seal assemblies replaced because of leakage of the fluid being pumped due to wear to or damage of the packing seal assemblies by the pumped fluid. Further, more and more oil wells are being produced with hydraulic pumping systems, and the horsepower requirements are increasing as the wells get deeper. As the pressure increases, the life of packing seals decreases.

In recent years progressive cavity pumps have also been developed for producing oil wells using rotating sucker rods. In progressive cavity pumping systems the stuffing box packing seals do not receive any lubrication from the fluid being pumped because the polished rod is rotating in the stuffing box instead of reciprocating. This is in contrast with a beam type pumping unit in which the polished rod reciprocates within the fluid being pumped. Notably, progressive cavity pumping systems generate a large amount of heat around the polished rod due to the lack of lubrication, and thus carry a high maintenance requirement so as to control the leakage of produced fluid through the stuffing box seal. Often, maintenance may not be performed with enough frequency, or may not be sufficient to prevent a leak event, which may occur without warning or indication.

In an oil production system, the polished rod is positioned within a chamber holding heavy oil, and the heavy oil coats the polish rods. Within this chamber, the heavy oil may cause the polished rod itself to degrade by, for example, causing mineral scale build-up or causing corrosion pitting. The condition of this polished rod can also affect the rate at which the fluid seal and packing wear, such that the packing and seals around a deteriorated polished rod deteriorate more quickly. Consequently, leakage through the packing can increase or the packing may need to be serviced or replaced more frequently.

Leakage in environmentally sensitive applications is particularly troubling. For example, it is desirable to have little to no leakage from stuffing boxes used in connection with a wellhead installed near open water or on a muskeg. Accordingly, what is desired are apparatus, methods and systems for enabling a stuffing box to remain functional and not leak heavy oil. It is also desired that as packing within a stuffing box wears, an indicator signal be sent to notify a user that service is needed. It is also desired to remove as much as possible the heavy oil or other fluid which may coat a polished rod and cause it to deteriorate.

### BRIEF SUMMARY OF THE INVENTION

The present invention relates to fluid seals and, more particularly, to fluid seals used in connection with a stuffing box. More particularly, aspects of the present invention relate to fluid seals for sealing around a rotating and/or reciprocating shaft, such as a polished rod, used in connection with a wellhead.

According to one embodiment, a stuffing box for sealing around a shaft is disclosed in which said stuffing box comprises at least one seal for sealing around the circumference of a shaft. Additionally, the stuffing box includes a wear indicator that is associated with the seal and which is adapted to provide an indication of when the seal has deteriorated to a predetermined level. For example, the wear indicator may provide an audible, visual, or tactile indication that the seal has deteriorated and is in need of service. In some embodiments, the shaft that the seal engages is a polished rod used in connection with a wellhead.

A variety of different seals may be used. For example, in some embodiments, a seal may comprise a tapered seal. In such embodiments, the stuffing box may optionally include a spring positioned against the tapered seal and configured to bias the seal against the surface of the shaft. The stuffing box can also include a guide to facilitate insertion of the shaft within the stuffing box and engagement of the seal with the shaft.

In some embodiments, the seal includes packing for engaging the circumference of the shaft and a compression bag that compresses the packing against the shaft. Alternatively, or in addition thereto, the seal can have first and second seals, in which a floating plate is in contact with a first seal and in which the second seal is positioned below the first seal. A spring may be positioned between the floating plate and the second seal, and around and linked to the first seal. The spring can exert a biasing force that compresses the first and second seals against the shaft.

In another embodiment, a stuffing box has a seal that uses a spring to cause a seal to form around the shaft. The spring may be linked to a tapered guide. A second tapered guide may also be used and between the two tapered guides a wiper seal may be compressed against the shaft. The force of the spring can thus cause the first tapered guide to compress the wiper seal between the two tapered guides. In another embodiment, the seal comprises a crown seal compressed between platform rings that each use a spring to bias the crown seal against the shaft. In still another embodiment, a packing ring is placed around the shaft and has a notched formed therein to receive an angled plate which acts as a spring and preloads the packing ring to bias the packing ring against the shaft.

According to another embodiment, a stuffing box is described which includes a housing with upper and lower bodies, and which can be selectively detached. A first seal is formed within the upper body and a second seal is formed within the lower body. Each seal includes a wedge insert and tapered packing, such that in the upper body, the wedge compresses the tapered packing against the shaft and an internal surface of the upper body, whereas in the lower body, the wedge insert compresses the tapered packing against the shaft and an internal surface of the lower body. Optionally, a tapered bushing is included in the housing to receive and align the shaft with the stuffing box.

These and other features and aspects of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof that are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1A is a partial cross-sectional view of an environment in which an exemplary stuffing box may be utilized in connection with aspects of the present invention;

FIG. 1B is a cross-sectional view of the stuffing box of FIG. 1A;

FIG. 2 illustrates a cross-sectional view of an exemplary stuffing box with a wear indicator and packing at the distal and proximal ends of the stuffing box;

FIG. 3 illustrates a cross-sectional view of an exemplary stuffing box with a wear indicator and packing located at a medial portion of the stuffing box;

FIG. 4 illustrates a partial cross-sectional view of an exemplary stuffing box with a wear indicator and packing along the length of the stuffing box and within a compression bag;

FIG. 5 illustrates a cross-sectional view of an exemplary stuffing box with a wear indicator and having a horizontal plate floating on layers of packing;

FIG. 6 illustrates a cross-sectional view of an exemplary stuffing box with a wear indicator and having a seal compressed within tapered guides;

FIG. 7 illustrates a cross-sectional view of an exemplary stuffing box with a wear indicator and having a compressed crown seal;

FIG. 8 illustrates a cross-sectional view of an exemplary stuffing box contained within a housing and having multiple wedge packing assemblies;

FIG. 9A illustrates a cross-sectional view of an exemplary stuffing box contained within a housing and having multiple wedge seals and shaft scrapers;

FIG. 9B illustrates an alternative partial cross-sectional view of the stuffing box of FIG. 9A;

FIG. 10A illustrates a cross-sectional perspective view of an exemplary stuffing box having multiple wedge seals and a tapered bushing;

FIG. 10B illustrates an additional cross-sectional view of the stuffing box of FIG. 10A; and

FIG. 11 illustrates a cross-sectional view of a portion of a stuffing box, in which a spring preloads the packing within the stuffing box.

### DETAILED DESCRIPTION OF THE PREFERRED EMBODIMENTS

The embodiments described herein extend to methods, systems, assemblies, and apparatus for creating fluid seals around a shaft. The apparatuses of the present invention are configured to therefore provide a fluid seal in which little to no leakage occurs during use and in which prior to a leakage event, the apparatus provides an indication that one or more seals have deteriorated.

Since current stuffing boxes and apparatuses for sealing around a shaft eventually fail, without warning, to produce a major leakage event, an apparatus is described that is configured to prevent major leakages, or at least warn an operator prior to an occurrence of a major leakage, while also maintaining little to no leakage during operation, and which can be used in a wide range of environments and situations in which a seal around a shaft or rod is desired. Consequently, in applications and environments in which toxic or hazardous fluids are utilized, apparatus according to the present invention can be utilized to provide safety to an operator as well as enable use or extraction of the hazardous or toxic fluids in environmentally sensitive areas.

Exemplary embodiments of the invention therefore relate to a stuffing box for sealing around a shaft used in connection with a wellhead for extracting oil. A stuffing box according to the present invention can protect a polished rod used within the wellhead from corrosion, can reduce degradation of seals within the stuffing box, and can protect against leakage of hazardous fluids.

Reference will now be made to the drawings to describe various aspects of exemplary embodiments of the invention. It is understood that the drawings are diagrammatic and schematic representations of such exemplary embodiments, and are not limiting of the present invention, nor are any particular elements to be considered essential for all embodiments or that elements be assembled or manufactured in any particular order or manner. No inference should therefore be drawn from the drawings as to the necessity of any element. In the following description, numerous specific details are set forth in order to provide a thorough understanding of the present invention. It will be obvious, however, to one of ordinary skill in the art that the present invention may be practiced without these specific details. In other cases, well known aspects of stuffing boxes, fluid seals, and packing are not described in detail herein in order to avoid unnecessarily obscuring the novel aspects of the present invention.

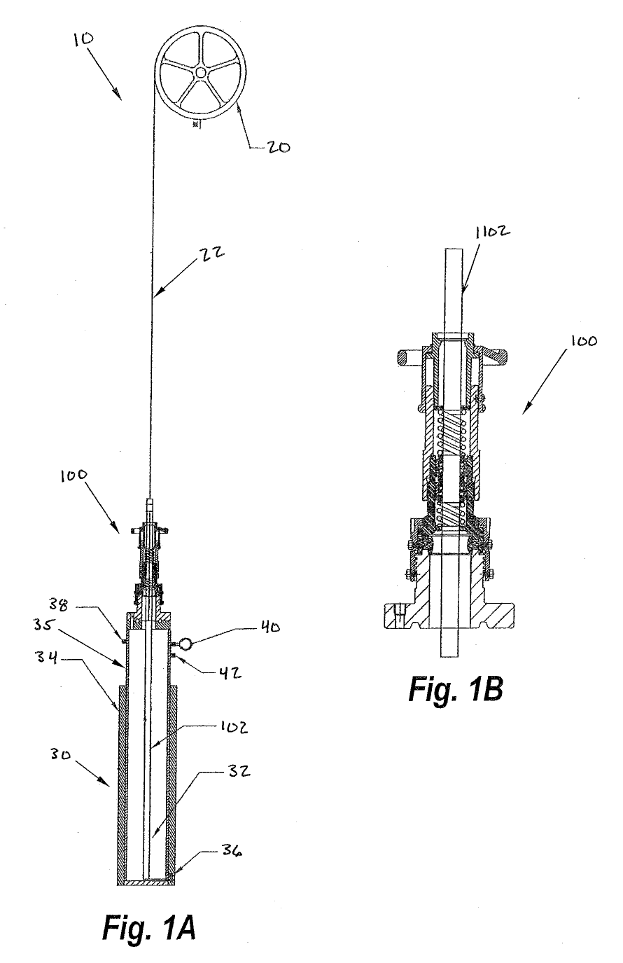

FIG. 1 and the following discussion are intended to provide a brief general description of a suitable environment in which embodiments of the invention may be implemented. While a general purpose fluid recovery system is described below, this is but one single example, and embodiments of the invention may be implemented with other types of fluid recovery systems, in a boat, or in nearly any other environment where it is desirable to seal around a shaft to prevent leakage into our out of a stuffing box.

FIG. 1 thus illustrates an example of a suitable fluid recovery environment 10 in which the embodiments of the invention may be implemented, although as made clear above, the fluid recovery environment 10 is only one example of a suitable environment and is not intended to suggest any limitation as to the scope of use or functionality of an embodiment of the invention. Neither should the fluid recovery environment 10 be interpreted as having any dependency or requirement relating to any one or combination of components illustrated in the exemplary operating environment 10.

With reference to FIG. 1, an exemplary system for implementing an embodiment of the invention includes a general purpose fluid recovery system connected to a wellhead 30. The illustrated system includes a reciprocating fluid recovery assembly in which a flywheel 20 is coupled to a shaft 102. In particular, a wire 22, which may be a tension wire, is connected to each of flywheel 20 and shaft 102. As flywheel 20 rotates, wire 22 moves vertically in an upward or downward direction, thereby also causing shaft 102 to move vertically in a corresponding direction. As discussed herein, shaft 102 may be any suitable shaft. For example, shaft 102 may be a polished rod usable for oil extraction systems, may be a rotating shaft, may be a prop shaft for watercraft, or may be any other rotating shaft for which a fluid-tight seal is desirable.

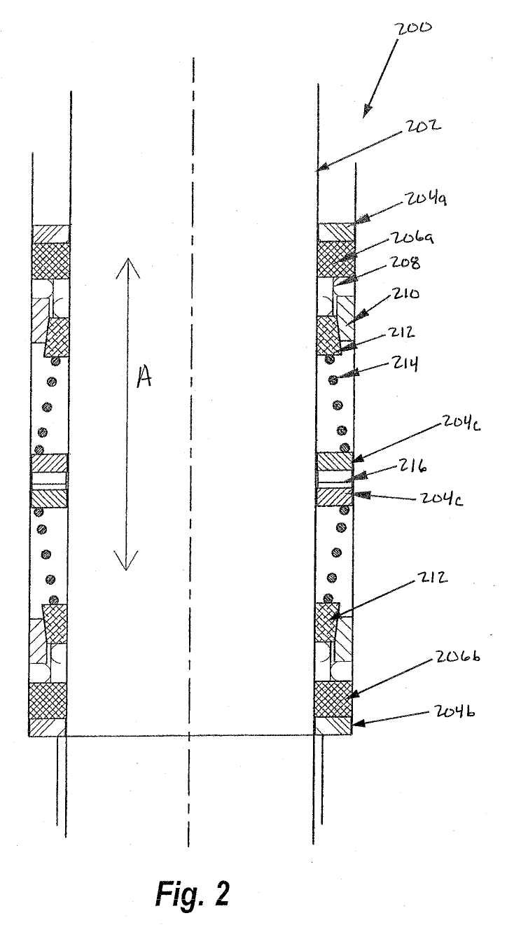

In the illustrated embodiment, shaft 102 passes through a stuffing box 100 and into wellhead 30. Stuffing box 100 is illustrated schematically and can include any of a variety of components and assemblies. For example, stuffing box 100 may be a stuffing box as described hereafter with respect to FIGS. 2-11.

In the illustrated embodiment, shaft 102 passes through the full length of stuffing box 100 and into the wellhead 30, where it may come into contact with fluid 32 contained within a containment shaft 35. Fluid 32 may be any of a variety of different fluids and may include, by way of example and not representation, petroleum or oil, water, lubricants, or a mixture thereof.

Fluid 32 may be kept under pressure so as to, for example, control the extraction rate of the fluid. Accordingly, in the exemplary environment 10 illustrated in FIG. 1, a pressure inlet 38 is formed in or otherwise coupled to containment shaft 35. To monitor the pressure within shaft 35, a pressure gauge or sensor 40 may also be coupled to containment shaft 35. When maintaining fluid 32 under pressure, heat may also be produced, thereby increasing the temperature of the contained fluid 32. Accordingly, a temperature sensor 24 may optionally be coupled to shaft 35 to monitor the temperature and to ensure the fluid remains at a desirable temperature. To accommodate elevated temperatures, a thermal jacket 34 may also surround at least a portion of shaft 35. Furthermore, in some embodiments, shaft 35 includes a drain 36 to allow fluid 32 to be released from within the hollow center of containment shaft 35.

As noted previously, environment 10 is but one example embodiment for utilizing aspects of the present invention. In other examples, for instance, a hydraulic pumping system or a progressive cavity pump may also be used in connection with stuffing box 100 of environment 10.

Now turning to FIGS. 2-11, various example embodiments of a stuffing box suitable for use in connection with environment 10 of FIG. 1 are illustrated. As illustrated in FIG. 2, for example, a suitable stuffing box 200 is illustrated. In the illustrated embodiment, a shaft 202, which may be a polished rod in an exemplary embodiment, passes through stuffing box 200 along a longitudinal axis of stuffing box 200. To allow shaft 202 to be easily inserted and properly aligned within stuffing box 200, one or more shaft guides may be used. In the illustrated embodiment, for instance, a set of guides 204a and 204b are located at the proximal and distal ends of stuffing box 200, respectively. Accordingly, as an operator attempts to insert shaft 202 into stuffing box 200, proximal guide 204a guides shaft 202 into stuffing box 200. Additionally proximal guide 204a can align shaft 202 such that it extends in a longitudinal direction along arrow A, thereby guiding shaft 202 to distal guides 204b, where shaft 202 then exits stuffing box 200. Optionally, one or more medial guides 204c may also be used to further facilitate proper alignment of shaft 202 within stuffing box 200. For instance, in the illustrated embodiment, two medial guides 204c are positioned within stuffing box 200 and spaced by a spacer 216, such as a washer. Thus, according to one embodiment of the present invention, guide 204a can guide shaft 202 into stuffing box 200, guide 204b can guide shaft 202 out of stuffing box 200, and one or more medial guides 204c may guide and/or support shaft 202 within stuffing box 200.

It will be appreciated that any suitable mechanism usable to guide shaft 202 and properly align it within stuffing box 200 may be used as guides 204a-c. In one embodiment, for example, guides 204a-c are generally circular in shape and have an opening in the interior thereof through which shaft 202 may be inserted. Additionally, guides 204a-c may be formed of any suitable material. For instance, according to one embodiment, guides 204a-c are formed of a rigid metal, plastic, composite, or other material. Accordingly, guides 204a-c may be formed of aluminum, brass, steel, or any other suitable material. In is also not necessary that guides 204a-c always cause shaft 202 to be positioned in a substantially vertical position. For example, in another embodiment, the stuffing box may be configured to have guide components which guide a shaft horizontally through the stuffing box. In still another embodiment, the guides may direct a shaft through the stuffing box at an angle.

Stuffing box 200 may also include additional components which facilitate maintaining a seal around shaft 200 as it reciprocates (e.g., along arrow A) and/or rotates. For example, in the illustrated embodiment, one or more packing elements 206 may be positioned within stuffing box 200, and around the circumference of shaft 202. Packing elements 206a and 206b are configured to create a seal around the outer circumference of shaft 202, thereby preventing or substantially reducing the amount of fluid which can leak out of stuffing box 200.

In the illustrated embodiment, for instance, a packing element 206a is positioned within the interior of stuffing box, and is adjacent to proximal guide 204a. A second packing element 206b may also be positioned adjacent distal guide 204b. As guides 204a and 205b provide openings through which shaft 202 may enter and exit stuffing box 200, packing elements 206a and 206b are therefore positioned around the openings in stuffing box 200.

Any suitable packing or sealing materials may be used to form packing elements 206a and/or 206b. For instance, according to one embodiment, packing elements 206a and 206b may be a gasket and/or may be made of any combination of graphite, carbon, fibrous materials, and/or braided materials.

For packing elements 206a and 206b to maintain an effective seal around shaft 202, packing elements 206a and 206b may be maintained tightly packed against guides 204a and 204b. A tight packing can be maintained, in one embodiment, by including one or more springs 214 within stuffing box 200. In the illustrated embodiment, for instance, two helical, tapered springs 214 are included in stuffing box 200. In particular, a spring 214 is placed around shaft 202 on each of the proximal and distal sides of medial guides 204c. Springs 214 can be placed adjacent to guides 204c, and may be abutting guides 204c.

The opposing end of springs 214 may be proximate to, and can optionally engage, an additional sealing element 212. In the illustrated embodiment, springs 214 are configured to exert a biasing force against sealing elements 212 to thereby press sealing elements 212 toward packing elements 206a and 206b. Thus, springs 214 can cause packing elements 206a and 206b to remain tightly packed and tightly pressed against guides 204a and 204b, thereby maintaining an effective seal that prevents fluid contained within stuffing box from leaking into the ambient environment.

As described above, in some embodiments stuffing box 200 may be connected to a wellhead or other environment in which received fluids are maintained at elevated pressures and/or temperatures. Accordingly, in some embodiments, springs 214 are adapted to maintain their structural strength and integrity at high temperatures. For instance, according to one embodiment, springs 214 may be made of metals having high melting points. In one example embodiment, and by way of representation and not limitation, springs 214 may be made of a nickel-chromium alloy material which is resistant to corrosion and oxidation, and which maintains high tensile and creep-rupture properties at elevated temperatures up to at 1300° F. (approximately 700° C.).

In some embodiments, sealing element 212 may be placed directly against packing elements 206a and 206b to compress packing elements 206a and 206b against guides 204a and 204b, respectively, thereby maintaining an effective seal against fluid leakage. In other embodiments, however, one or more intermediate components may be placed between sealing elements 212 and packing elements 206a and 206b. Additionally, sealing elements 212 may optionally be configured to move relative to packing 206a and 206b.

As shown in FIG. 2, for example, sealing elements 212 are placed adjacent to, and optionally abut, shaft 202. Moreover, in the example illustrated embodiment, sealing elements 212 are tapered on their external surfaces and that surface engages an additional guide component 210. Guide component 210 can be tapered to approximately match the taper on sealing elements 212. In an alternative embodiment, however, guide component 210 may be compressible such that as sealing element 212 engages a guide component 210, the tapered surface on sealing element 212 compresses guide component 210 to maintain a tight seal therebetween. Moreover, in embodiments in which sealing element 212 can move, including, for example, when spring 214 expands or contracts, sealing element can slide along guide component 210 while maintaining pressure on packing elements 206a and 206b.

As noted above, packing elements 206a and 206b may be formed of any of a variety of materials and may have any suitable configuration. Packing may therefore be used which has different structural strengths and exhibits different mechanical properties. Regardless of the packing material used, packing and sealing elements may still wear over time and may thus require replacement or repair. In the event that such elements are not repaired or replaced, the packing may fail, thereby breaking the seal of the stuffing box and allowing fluid to leak.

The packing materials may, however, continue to maintain a suitable seal up until the point of failure. Thus, according to another embodiment of the present invention, stuffing box 200 may include a warning system that indicates when packing has undergone a predetermined amount of wear, thereby alerting an operator that the packing needs to be replaced before it can fail. Thus, the warning system may allow an operator to anticipate failure of the seals in stuffing box 200 before failure occurs.

In the embodiment illustrated in FIG. 2, for instance, a warning system may include one or more wear indicators 208. Any suitable wear indicator 208 may be used. For instance, according to one embodiment, wear indicator 208 may be placed between sealing element 212 and packing 206a, and can include a proximity sensor that detects the distance between the sensor and, for example, guide 204a. As packing 206a wears, it may compress, thereby causing wear indicator to become closer to guide 204a. Upon reaching a predetermined distance from guide 204a, wear indicator 208 may emit an audible tone to alert the operator of the need to replace packing 206a.

It will be appreciated that still other types of mechanical, electrical, electro-mechanical, or other types of wear indicators may also be used. For example, according to another embodiment, wear indicator 208 includes a transmitter and transmits a wireless signal to a receiver. The receiver can then display a warning indicating the stuffing box in need of repair and, optionally, which packing is close to failure. According to another embodiment, wear indicator 208 is purely mechanical. For instance, wear indicator 208 may comprise a metal element. As packing 206a wears, packing 206a may continue to provide a suitable seal, but may become compressed or, in other embodiments, may take on fluid or other materials and can expand. Wear indicator may include a curled piece of metal, or a metal bulge, that rubs against the housing for stuffing box 200, or against another element upon occurrence of a specified amount of wear. When such rubbing occurs, wear indicator 208 may emit an audible sound, such as a squeal, indicating that a limited amount of useful packing remains and that the operator should replace or service the stuffing box soon. In such an embodiment, wear indicator 208 may thus operate similar to an automotive disc braking system in which as the brake pad wears, a steel spring begins to rub against the rotor and squeal.

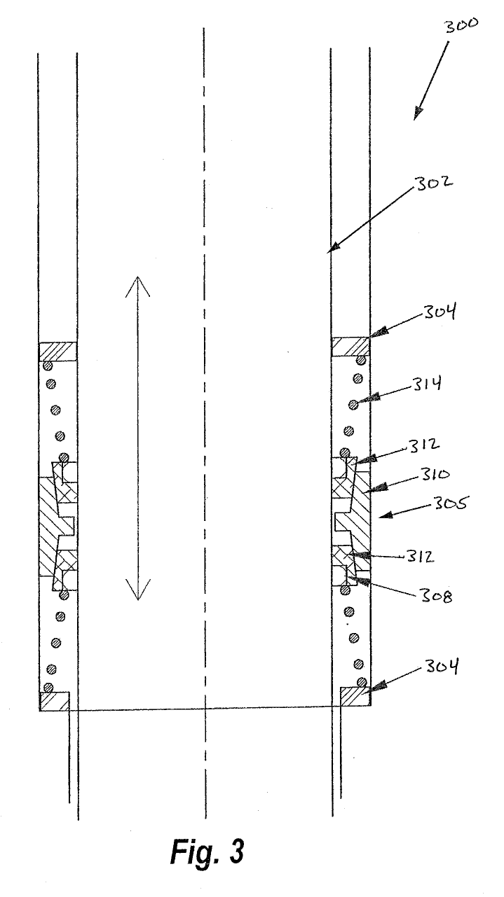

Referring now to FIGS. 3-11, alternative embodiments of a stuffing box are shown in accordance with additional aspects of the present invention. The apparatus of the alternative embodiments include components functionally similar to that of the device previously described above and shown in FIG. 2, in many respects. Accordingly, where certain features are common to the additional embodiments, such features will not be described in detail in relation to the alternative embodiment wherein those components function in the manner as described above and are hereby incorporated into the alternative embodiments described below.

Turning now to FIG. 3, a cross-sectional view of an example alternative embodiment of a stuffing box 300 is illustrated. In the illustrated embodiment, stuffing box 300 is configured to receive a shaft 302 and prevent or substantially reduce the leakage of fluid from a connected fluid reservoir (not shown).

In particular, stuffing box 300 can include one or more guides 304. Guides 304 are, in this embodiment, located on the proximal and distal ends of stiffing box 300 and serve to guide shaft 302 into and out of stuffing box 300. Additionally, in this embodiment, one or more springs 314 may be positioned adjacent guides 304 on the interior of stuffing box 300. Springs 314 can be, for example, high temperature and/or high tension springs, and can be configured to exert a biasing force against guides 304.

Opposite guides 304, springs 304 may engage a sealing assembly 305 used to eliminate or reduce leakage out of a fluid reservoir. For example, in this embodiment, sealing assembly 305 includes a first sealing element 312 which is engaged with spring 304. In the illustrated embodiment, first sealing element 312 has a first surface which mates against sleeve 302. First sealing element 312 can also include an opposing second surface which is tapered. In the illustrated embodiment, for instance, the second surface of sealing element 312 is tapered inward, such that the width of sealing element 312 decreases as it approaches the middle of stuffing box 300.

To create a tight fluid seal, the tapered outer surface of sealing element 312 mates with a second sealing element 310. Second sealing element 310 may also be tapered to match the taper of first sealing element 312, although it will be appreciated that this feature is optional. For instance, second sealing element may be flexible or may otherwise compress to have a temporary taper when engaged with first sealing element 312. Such a mating taper, whether permanent or temporary, can thus cause the width of sealing component 310 to increase as it approaches the middle of stuffing box 300. In other words, in contrast with first sealing component 312 which has its width decrease towards the interior of stuffing box 300, the width of second sealing component 310 increases towards the interior of stuffing box 300.

As shown in FIG. 3, stuffing box 300 is substantially symmetrical about a midline passing through the middle of second sealing component 310. It will be appreciated that this is exemplary only and that other embodiments are contemplated. For instance, although a single second sealing component 310 is illustrated as engaging with two first sealing components 312, two or more second sealing components may separately engage first sealing components 312. In addition, as further illustrated, stuffing box 300 may also include one or more wear indicators 308. Wear indicators 308 may be, for instance, located within a groove in first sealing components 312, and can operate in any manner suitable to indicate when first sealing elements 312 and/or second sealing element 310 are worn, including in any manner previously described.

Sealing elements 310 and 312 can be formed of any suitable material useful for creating a fluid seal. For instance, as described previously, sealing elements 310 and 312 can include a packing material such as carbon or graphite, and/or can be a gasket. Sealing elements 310 and 312 may comprise the same sealing material or may be different. For instance, in one embodiment, sealing elements 312 comprise a graphite and/or carbon packing material while sealing element 312 comprise a polymeric material. Accordingly, it will be appreciated that a stuffing box may maintain a fluid seal which does not rely on or use additional fluids other than those passed in from the external fluid reservoir and which coat shaft 302.

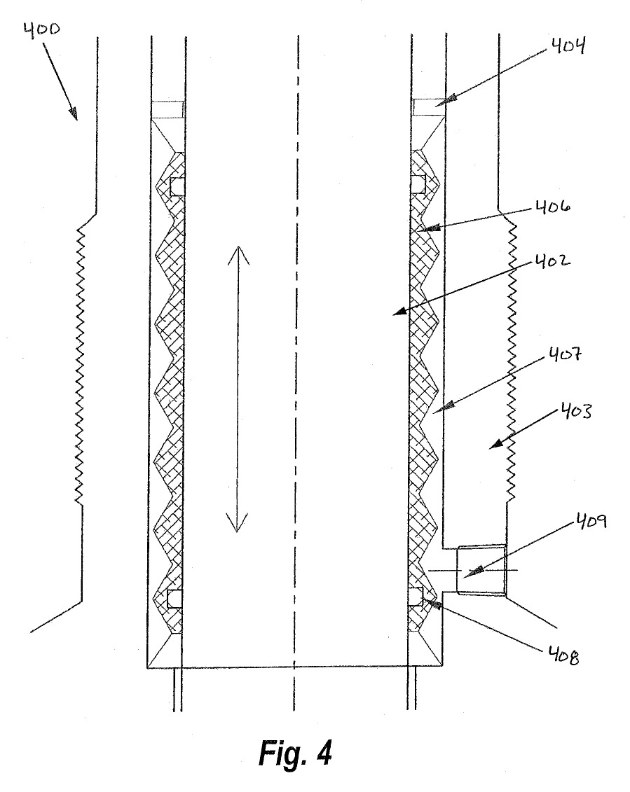

Now turning to FIG. 4, still another example embodiment of a stuffing box 400 is illustrated. As previously described, stuffing box 400 may enclose and seal around a shaft 402 which also engages fluid within a fluid reservoir (e.g. the chamber within shaft 35 of FIG. 1). The fluid from the reservoir may also be carried within the interior of shaft 402, thereby allowing the fluid to be extracted from the reservoir, although fluid may be removed from the reservoir through other means, and it is not necessary that shaft 402 be hollow or have a chamber therein. In either event, however, fluid can be extracted or contained within the reservoir with little or no leakage through stuffing box 400.

In the illustrated embodiment of stuffing box 400, shaft 402 may include a polished rod which is passed into stuffing box 400 and guided therein by one or more guides 404. In the illustrated embodiment, a single guide 404 is placed at the proximal end of stuffing box 400, although in view of the disclosure herein it will be appreciated that one or more additional guides can also be located at the proximal end of stuffing box 400 or inside stuffing box 400 at a medial location.

To create a seal around shaft 404, a packing 406 may be placed inside stuffing box 400 and may fill substantially the entire chamber within stuffing box 400. For instance, in the illustrated embodiment, packing 406 is positioned such that it engages shaft 402 along substantially the entire elongate length of stuffing box 400.

Maintenance of a fluid seal may be improved by, for example, compressing packing 406 within stuffing box 400. Accordingly, in this embodiment, a compression bag 407 is placed around the outer perimeter of packing 406. Compression bag 407 may allow, for example, air to be removed from within stuffing box 400, thereby creating a vacuum environment which compresses packing 406. According to one embodiment, compression bag 407 is located within a housing structure 403 and the housing includes a port 409 which can be used to remove air from within compression bag 407. For instance, port 409 may have standard threads which allow it to be connected to a vacuum pump. Port 409 extends through compression bag 407 and is in communication with packing 406. Accordingly, when the connected vacuum pump (not shown) is engaged, the vacuum pump can easily extract air from within compression bag 407, including air within packing 406, to create a fluid seal.

According to another embodiment, port 409 is only in connection with compression bag 407 and is not in fluid communication with packing 406. Consequently, when a vacuum pump is engaged, the pump can cause compression bag 407 to contract, thereby compressing packing 406 without removing the air from packing 406.

As further illustrated in FIG. 4, stuffing box 400 can optionally include one or more wear indicators 408, as described above. In particular, as packing 406 wears a predetermined amount, wear indicator 408 can then provide an audible, visual, tactile, or other indicator to alert an operator that stuffing box 400 is in need of service.

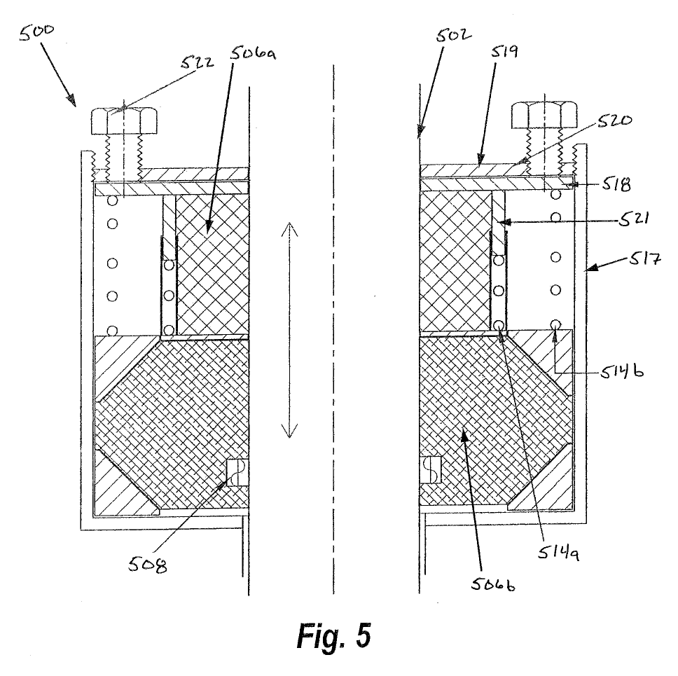

Still another embodiment of an exemplary stuffing box 500 is illustrated in the cross-sectional view of FIG. 5. In this embodiment, stuffing box 500 is configured to maintain a seal by including a floating plate 518 which engages and maintains packing 506a in a compressed, packed state. Accordingly, stuffing box 500 can maintain a fluid seal around a shaft 502 passing through stuffing box 500.

In particular, stuffing box 500 includes a housing 517 for containing the components of stuffing box 500, in which an opening is formed in the distal end of housing 517 to allow shaft 502 to pass therethrough as it is positioned at least partially within a fluid reservoir, as it reciprocates, and/or as it rotates. Housing 517 has, in this embodiment, a generally rectangular configuration, and is open at its proximal end. Stuffing box 300 may further include a removable head 520 positioned within the open proximal end. Removable head 520 is, in this example, selectively attachable or removable from housing 517 by using one or more bolts 522. Bolts 522 may be tension bolts such that as bolts 522 are tightened on head 520 within housing 517, head 520 becomes selectively fastened thereto. Head 520 may also include an opening therein through which shaft 502 is inserted into, and removed from, stuffing box 500.

Stuffing box 500 can further include a floating plate 518 positioned inside stuffing box 500, and within the chamber formed by housing 517 and head 520. Floating plate 518 includes, in this embodiment, a horizontal plate portion 519 and one or more vertical extensions 520 extending distally from the horizontal plate 519. A pair of springs 514a and 514b may also support floating plate 518, and allow it to move—or float—within stuffing box 510. In particular, in the illustrated embodiment, a short spring 514a is sized such that it surrounds shaft 502 and engages the distal end of vertical extensions 521. Optionally, a cavity can be formed within housing 517 to facilitate positioning of short spring 514a. In such a case, vertical extensions 521 may also extend into the cavity, such that the walls of the cavity act as a guide for vertical extensions 521 and floating plate 520 as it moves proximally and distally.

As further illustrated, a long spring 514b may also be located within housing 517 and can engage the distal surface of horizontal plate 519. Accordingly, floating plate 518 may be supported by each of springs 514a and 514b. Thus, as springs 514a and 514b expand or contract, floating plate 518 moves in a corresponding proximal or distal direction. It should also be appreciated that it is not necessary that each of springs 514a and 514b be used. For instance, in another embodiment, only one of springs 514a or 514b may be used.

To create a fluid seal in stuffing box 500, packing 506a may be placed around shaft 502. In the illustrated example, packing 506a is a first packing that is placed around shaft 502, and between shaft 502 and spring 514a. In embodiments in which spring 514a is contained within a spring chamber, packing 506a may thus be compressed between shaft 502a and the walls of the spring chamber.

In some embodiments, stuffing box 500 may also include a second packing 506b. In the embodiment illustrated in FIG. 5, for example, first packing 506a and second packing 506b may be formed in layers. In particular, and by way of example only, first packing 506a may be positioned on top of, and proximal to, second packing 506b. Additionally, in some embodiments, second packing 506b may be positioned below, and thus at least partially support, one or both of springs 514a-b, although this feature is exemplary only. In other embodiments, one or both of springs 514a-b may extend the full height of stuffing box 500 and be supported by housing 517.

As noted above, packings 506a-b may be any suitable type of packing material. According to one embodiment, packing 506a is the same material as packing 506b. In another embodiment, however, packing 506a and packing 506b are different materials. For instance, second packing 506b may be made of a dense or hard packing material, while first packing 506a may be made of a soft packing material. Such an arrangement may allow packing 506b to support springs 514a-b, while soft first packing 506a may be compressible so as to allow plate 518 to float.

As will also be appreciated in view of the disclosure herein, stuffing box 500 can also include one or more wear detectors or indicators 508. In the illustrated embodiment, for instance, a wear indicator is located inside, or may be adjacent to, second packing 506b and can be used to detect when second packing has deteriorated or become worn to a predetermined level. Although not illustrated, it will also be appreciated that one or more additional wear indicators can be used in connection with first packing 506a to indicate which first packing 506a has worn down to an undesirable level.

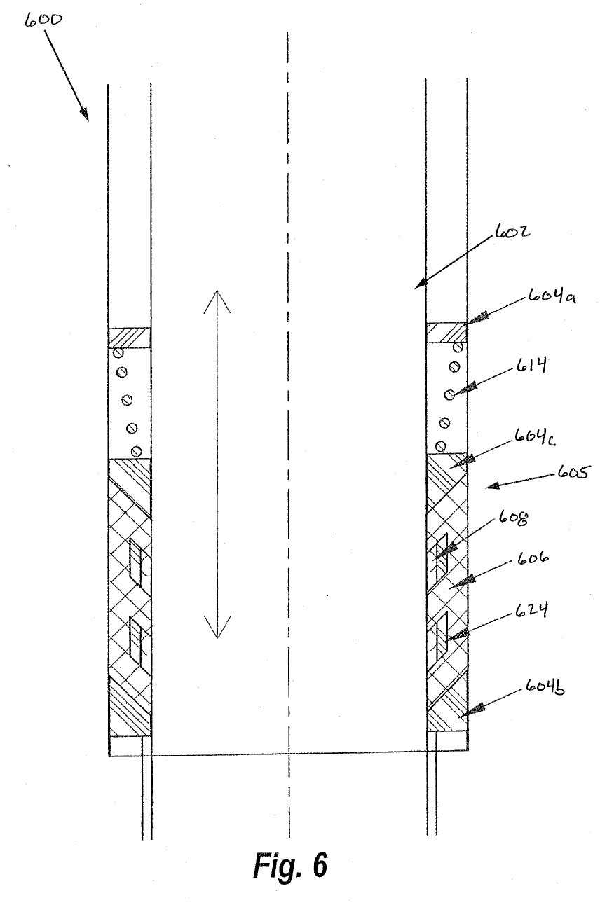

Turning now to FIG. 6, still another example embodiment of a stuffing box for creating a fluid seal around a shaft is illustrated and described. In the illustrated embodiment, a stuffing box 600 is adapted to create a fluid seal around a shaft 602. In the illustrated embodiment, one or more guides 604a-c are used to support and guide shaft 602 in stuffing box 600, as well as for supporting a sealing assembly 605 as described below.

In particular, in the illustrated embodiment, stuffing box 600 includes a proximal guide 604a at the proximal end of stuffing box 600, and a distal guide 604b at the distal end of stuffing box 600. Additionally, between proximal guide 604a and distal guide 604b, a spring 614 can be positioned so as to create pressure on sealing assembly 605, which is also disposed between proximal guide 604a and distal guide 604b. In this embodiment, a first end of spring 614 engages the distal surface of proximal guide 604a, while the opposing, second end of spring 614 engages the proximal surface of sealing assembly 605. In this manner, spring 614 can be compressed or expanded as necessary to compress sealing assembly 605 against distal guide 604b to create a fluid seal.

Sealing assembly 605 can include any of a variety of materials and components, and can include any assembly necessary to create a fluid seal around shaft 602. In the illustrated embodiment, which illustrates a sealing assembly 605 which is merely illustrative of one of many suitable sealing assemblies, sealing assembly 605 includes an additional guide 604c and a seal 606. In particular, guide 604c is a medial guide between proximal guide 604a and distal guide 604b and can provide any of a number of different features. For instance, medial guide 604c can be used to guide and support shaft 602 as well as be used to facilitate compression of seal 606 by spring 614.

Seal 606 of sealing assembly 605 is thus disposed and compressed between medial guide 604c and distal guide 604b. Seal 606 can have any of a variety of different configurations and can include any of a variety of suitable materials. For instance, seal 606 may include packing, one or more gaskets, may be a wiper seal, or the like. In one embodiment, such as where seal 606 is a wiper seal, seal 606 may be formed of a flexible material which is compressible between guides 604b-c. For instance, seal 606 may be formed of a natural or synthetic rubber, a polymer, or any other suitable flexible material.

Where seal 606 is formed of a flexible material, one or more rigid supports 624 may optionally be placed within seal 606, as shown in FIG. 6. Rigid supports 624 may, for example, be a metal or other rigid material which is inserted within the flexible material of seal 606 to provide additional reinforcement and support to seal 606. Optionally, one or more wear indicators 608 may also be placed within seal 606. As described above, wear indicators 608 may be used to provide, for instance, a squeaker-type, audible indication of when seal 606 has degraded or worn-down to a predetermined state.

Medial guide 604c and/or distal guide 604b may also be configured to mate in the absence of seal 606. For example, guides 604b-c may be horizontal plates that have horizontal surfaces that mate together when seal 606 is removed. One feature of mating guides 604b-c is that when seal 606 is disposed between guides 604b-c, compression of medial guide 604c by spring 614 can cause substantially equal pressure to be applied to seal 606, such that the compression of seal 606 is about equal in all locations.

It will be appreciated, however, that other configurations of guides 604b-c may also be used, and guides 604b-c may be configured to mate without using horizontal plates. For instance, as illustrated in FIG. 6, guides 604b-c may have corresponding tapered configurations. In particular, in the illustrated embodiment, medial guide 604c is about flush against shaft 602, and tapers at its external surface such that the width of medial guide 604c decreases when moving from the proximal to distal end of medial guide 604c. In contrast, distal guide 604b may also be flush against shaft 602, but may taper in an opposing and mating manner, such that the width of distal guide 604b increases when moving from the proximal to distal end of distal guide 604b. The taper angle on guides 604b-c may also correspond such that the tapered surfaces of guides 604b-c may lay flush against each other when seal 606 is removed.

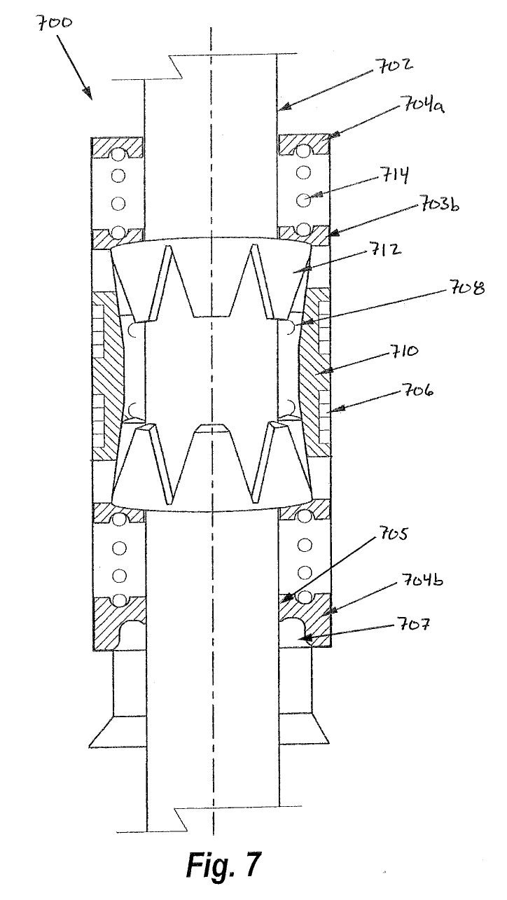

Now referring to FIG. 7, a partial cross-sectional view of another stuffing box is illustrated and which can be used to form a fluid seal around a reciprocating, rotating, or other shaft. In the illustrated embodiment, for example, a set of platform rings 704a engage a crown seal 712 to form the fluid seal around shaft 702.

In particular, and as illustrated in FIG. 7, a platform ring 704a may be positioned at the proximal end of stuffing box 700. Platform ring 704a includes an opening in a proximal surface through which shaft 702 can be inserted, and the sides of that opening can act as a guide to support and guide shaft 702 into and out of stuffing box 700. In some embodiments, a similar platform ring 704b may also be located at the distal end of stuffing box 700.

Platform ring 704a includes an upper ring 703a and a lower ring 703b, which have a spring 714 sandwiched therebetween. To facilitate positioning of spring 714 between upper and lower rings 703a-b, one or both of rings 703a-b may also include a retention groove therein. As illustrated in FIG. 7, the proximal and distal ends of spring 714 can thus sit within the retention groove on rings 703a-b, thereby securing spring 714 at a desired location.

As noted previously, a platform ring 704b may also be positioned at the distal end of stuffing box 700. In such embodiments, a seal 712 can be positioned between platform rings 704a and 704b. In one embodiment, such as that in FIG. 7, seal 712 can be a crown seal which engages the internal surfaces of each of platform rings 704a-b. In particular, seal 712 is sandwiched between platform rings 704a-b such that as platform rings 704a-b move inward, seal 712 is compressed, whereas if platform rings 704a-b move outward, seal 712 is allowed to expand.

As noted above, in one embodiment seal 712 may be a crown seal. In the illustrated embodiment, crown seal 712 has a generally cylindrical configuration and is adapted to enclose the outer circumference of shaft 702. Additionally, crown seal 712 includes distal and proximal crown portions which are each formed by alternating peaks and valleys. One feature of this alternating pattern is that it allows the cylindrical seal 712 to expand and contract. In particular, when platform rings 704a-b move apart, cylindrical seal 712 can expand by increasing the size of the valleys of the crown potions on seal 712. In contrast, when platform rings 704a-b move towards each other, thereby compressing seal 712, the peaks of crown seal 712 move closer together, thereby reducing the size of the alternating valleys.

Between the crown portions of seal 712 is an intermediate portion which can cooperate with a second sealing portion 710 to create a fluid seal around shaft 702. For instance, the intermediate, side portions of seal 712 can mate with, and compress against, second sealing portion 710 to create a fluid seal. Crown seal 712 and second sealing portion 710 can thus be formed of any suitable sealing material as described herein or known in the art.

To create a tight seal between seals 710 and 712, each may optionally be contoured, thereby improving the tightness of the seal. For example, in the illustrated embodiment crown seal 712 has an inward taper such that the width of crown seal 712 decreases at its middle. Seal 710 has a corresponding outward taper in which its width thus increases at its middle.

Other components may also be added to stuffing box 700 to increase the ability of stuffing box 700 to prevent or reduce fluid leakage. For instance, in some embodiments, packing 706 may also be added within seal 710. In other embodiments, however, packing may be additionally or alternatively added to seal 712 and/or between seal 710 and platform rings 704a-b. In still other embodiments, a wear indicator 708 may be added to stuffing box 700 to detect wear and deterioration of seal 710, crown seal 712, and/or packing 706. In such cases, wear indicator 708 can be positioned in any suitable location. For instance, wear indicator 708 can be placed within or on crown seal 712. A wear indicator may also be placed in or adjacent packing 706 or seal 710.

When shaft 702 is inserted into a fluid reservoir and then drawn into stuffing box 700, it will be appreciated that some of the fluid may coat the external surface of shaft 702 and thus also be drawn into stuffing box 700. In some cases, the fluid received within stuffing box 700 may act as a lubricant, thereby improving the performance of stuffing box 700. In other cases, however, the received fluid may be damaging to stuffing box 700. For instance, the fluid may contain dirt, soil, minerals, or other items which can be deposited on shaft 702 and/or inside stuffing box 700. Such deposits can, for example, damage spring 714, seals 710 and 712, and/or packing 706.

Accordingly, in some embodiments of the present invention, stuffing box 700 is equipped to at least partially remove fluid and/or deposits on shaft 700. For instance, in the illustrated embodiment, distal platform ring 704b can also include a scraper 705. In this embodiment, scraper 705 has a leading edge which engages shaft 702 as it reciprocates and/or rotates. The leading edge of scraper 705 is configured to scrape against the outer surface of shaft 702, thereby removing at least some of the fluid and/or deposits coating the outer surface of shaft 702. When engaged by scraper 705, the fluid and/or minerals then fall off shaft 702 and into cavity 707 of stuffing box 700. Within cavity 707, the deposits are prevented from contacting springs 714, seals 710, 712 and packing 706. As a result, there is a reduction in the fluids and deposits which are received inside the sealing portions of stuffing box 700, thereby prolonging the length of time in which stuffing box 700 can maintain an effective fluid seal.

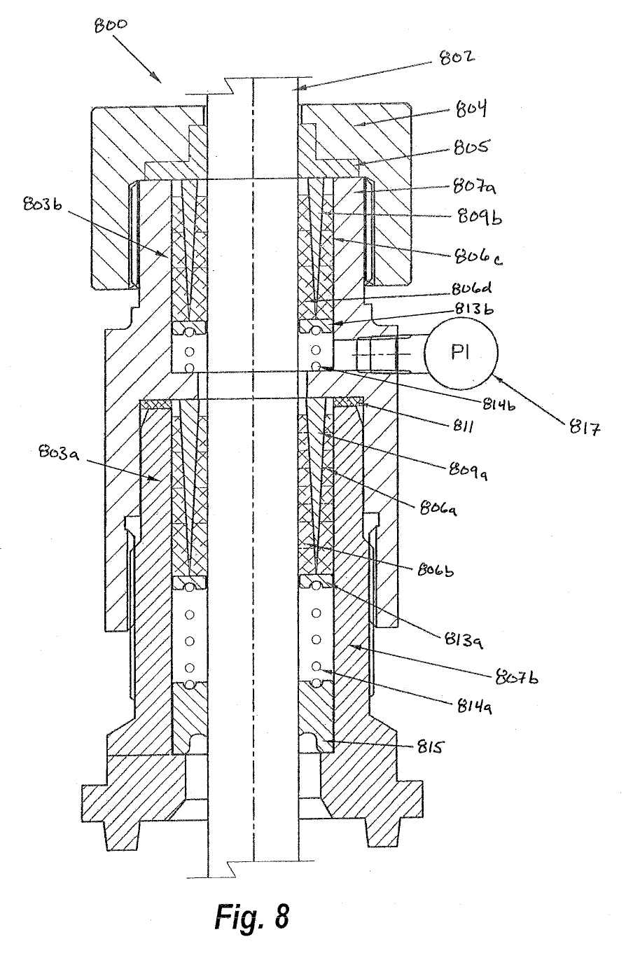

Still another example embodiment of a stuffing box according to the present invention is illustrated in FIG. 8. In the illustrated embodiment, a stuffing box 800 houses and seals fluids drawn through a shaft 802 within a housing. In particular, stuffing box includes a lower housing 807b which is adapted to be connected to a wellhead or other fluid reservoir. An upper housing 807a mates with lower housing 807b and creates a fluid seal therewith. In one embodiment, for instance, a gasket 811 is positioned between lower housing 807b and a lip on upper housing 807a to at least partially create a fluid seal.

In the illustrated embodiment, upper housing 807a is configured to receive lower housing 807b therein. Accordingly, upper housing 807a can include a female connector and lower housing 807b can include a male connector. It will be appreciated that this is exemplary only, however, and that other embodiments are contemplated. For instance, in other embodiments, a lower housing may receive the upper housing therein. To secure upper housing 807a to lower housing 807b, any suitable connection can be employed. For instance, lower housing 807b may have external threads received by mating internal threads on upper housing 807a. Any other suitable connector may also be used however. For example, upper housing 807a may be secured to lower housing 807b by using an interference fit, clamps, or any other connection may be made, for example, by using a threaded fastener, by using an interference fit, or another type of mechanical fastener. Alternatively, or in addition thereto, upper housing 807a may be secured to lower housing 807b by welding, an adhesive, or some other permanent or semi-permanent securement method.

When upper housing 807a is secured to lower housing 807b, a first fluid seal may be created. As noted above, for example, gasket 811 may create such a seal that prevents or reduces the amount of fluid which can leak from stuffing box 800. It will be appreciated, however, that other components may further be used to increase the performance of the fluid seal. For instance, any sealing components or assemblies as discussed previously with respect to FIGS. 2-7 may also be implemented within lower housing 807b to create an improved seal.

In the illustrated embodiment, the first seal may also be improved by using a wedge packing assembly 803a. In the exemplary wedge packing assembly 803a, a wedge insert 809a is fitted around shaft 802 and between shaft 802 and lower housing 807b. Wedge insert 809a may be formed of any suitable material and may be, for example, a rigid medial (e.g., steel, brass, etc.), or a rigid composite, polymer or other material.

Wedge insert 809a can be placed at the proximal end of lower housing 807b, and is, in this embodiment, also compressed between upper housing 807b and a platform ring 813a. Moreover, in this embodiment, wedge insert 809a tapers downward, such that its thickness at the distal end of wedge insert 809a is less than the thickness at the proximal end of wedge insert 809a, although this configuration may also be reversed. In other embodiments, the thickness may remain constant across the length of wedge insert 809a, or may change in other manners. For instance, in one embodiment, an insert may have a symmetrical shape in which the insert tapers inward from the proximal end toward the middle, and tapers outward from the middle toward the distal end. Such taper could also be reversed.

The distal surface of platform ring 813a is supported by a spring 814a. In this embodiment, the distal surface of platform ring 813a includes a groove into which spring 814a is positioned. Additionally, the distal end of spring 814a may then be supported against a distal end of lower housing 817b, or against a lower platform ring. In this embodiment, however, spring 814a is supported between platform ring 813a and a scraper 815 which can be adapted to clean debris and/or fluid from shaft 802.

To further improve the fluid seal of wedge packing assembly 803a, packing materials may also be situated around wedge insert 809a. For instance, in the illustrated embodiment, tapered outside packing 806a is compressed between wedge insert 809a and the internal surface of lower housing 807b. Similarly, tapered inside packing 807b can also be compressed between wedge insert 809a and shaft 802. It will be appreciated that packings 807a-b can each comprise a single piece, or may be a combination of pieces. For example, tapered outside packing 806a may be a single integral packing material, or may be comprised of layers of different pieces of packing. Similarly, tapered inside packing 806b may also be a single integral piece of packing, or may be comprised of different pieces stacked on each other. Accordingly, packings 806a-b may also be comprised of a single material or may be comprised of layers of different packing materials.

Additionally, or alternatively, a second seal can be created within stuffing box 700. For example, in the illustrated embodiment a second seal is created within upper housing 807a. In particular, a second wedge packing assembly 803b is formed around shaft 802b within upper housing.

Second wedge packing assembly 803b can be similar to first wedge packing assembly 803a in all material respects. For example, as illustrated in FIG. 8, second wedge packing assembly includes a tapered wedge insert 809 extending between the proximal end of upper housing 807a and a platform ring 813b. Platform ring 813b may also be supported on a spring 814b. In the upper wedge packing assembly 803b, spring 814b can be compressed between wedge insert 809b and a lip on upper housing 807a. In other embodiments, a lower platform ring may support the distal end of spring 814b.

Additional sealing materials may also be placed around wedge insert 809b. As illustrated in FIG. 8, for example, an outside tapered packing 806c may be placed between wedge insert 809b and the internal surface of upper housing 807a. Similarly, an inside tapered packing 806d may be placed between wedge insert 809b and shaft 802.

To repair or replace components forming the fluid seals in stuffing box 800, upper housing 807a may be removed from lower housing 807b. In this manner, each of first wedge packing assembly 803a and second wedge packing assembly 803b can be exposed and any of the components therein examined, replaced or repaired.

In some embodiments, it may not be necessary to disassembly upper and lower housings 807a-b to repair one or more fluid seals within stuffing box 800. For example, stuffing box 800 may be configured to allow an operator to more efficiently service stuffing box and to replace or repair one or more sealing components within stuffing box 800. For instance, in the illustrated embodiment, stuffing box 800 includes a removable cap 804 which is selectively attachable and detachable from upper housing 807a. By using corresponding thread profiles on cap 804 and upper housing 807a, for example, a user may efficiently remove or replace cap 804 on upper housing 807a. In other embodiments, however, cap 804 may be permanently or semi-permanently secured to upper housing 807a.

When cap 804 is removed, second wedge packing assembly 803b may be exposed to the operator for inspection, maintenance or repair. For instance, in the illustrated embodiment, wedge insert 809b is compressed between platform ring 813b and cap 804, such that as cap 804 is removed, wedge insert 809b can also be removed, along with packings 806c-d. Optionally, cap 804 may have a guide bushing 805 enclosed therein to facilitate insertion and removal of shaft 802. Guide busing 805 may be integrally formed within cap 804, or may be separable therefrom. In FIG. 8, for example, guide bushing 805 is a separate component which is inserted into a mating cavity formed in the distal end of cap 804. As a result, when cap 804 is secured to upper housing 807a, guide bushing 805 compresses wedge insert 809b.

Furthermore, in some embodiments, the pressure of fluid entering stuffing box 800 and/or the forces on springs 814a-b can be measured. For instance, in the illustrated embodiment, a port is formed in upper housing 807a and a pressure indicator 817 is connected thereto. As a result, fluid pressure can be measured and a measurement provided to an operator. The port may also be used to monitor the forces on springs 814a-b. Accordingly, in some embodiments, a port can additionally or alternatively be formed in lower housing 807b.

As discussed above, the one or more fluid seals in stuffing box 800 can be formed, at least in part, by using one or more packings and/or gaskets. It will be appreciated that any suitable gasket or packing may be used, and such may be selected based on the application for which stuffing box 800 is to be used. For example, in one embodiment, such as where stuffing box 800 is used in connection with a wellhead, packings 806a-d and/or gasket 811 may be formed of graphite or a combination of graphite and carbon. In other embodiments, such as where stuffing box 800 is used in connection with a prop shaft on a watercraft, packings 806a-d may be formed of a fibrous material, such as rope, and gasket 811 may be formed from rubber or a flexible polymeric material.

It should also be appreciated that the embodiment illustrated in FIG. 8 can have any suitable dimensions. For instance, in stuffing box 800, upper housing 807a mates with lower housing 807b to form, two cavities in which wedge packing assemblies 803a-b are placed. In the illustrated embodiment, first wedge packing assembly 803a has a length greater than that of second wedge packing assembly 803b, wedge insert 809a is longer than wedge insert 809b, and spring 814a is larger than spring 814b. In other embodiments, however, the relationship may be reversed with respect to one or more of the wedge insert, spring, or packing assemblies. In still other embodiments, the first and second wedge packing assemblies may be about the same size.

Although not illustrated in FIG. 8, in view of the disclosure herein, it will be appreciated that one or more wear indicators may also be used in connection with stuffing box 800. For example, a wear indicator may be positioned within, or adjacent to, packings 806a-d to provide an indicator to an operator when the packing is in need of service, and prior to failure.

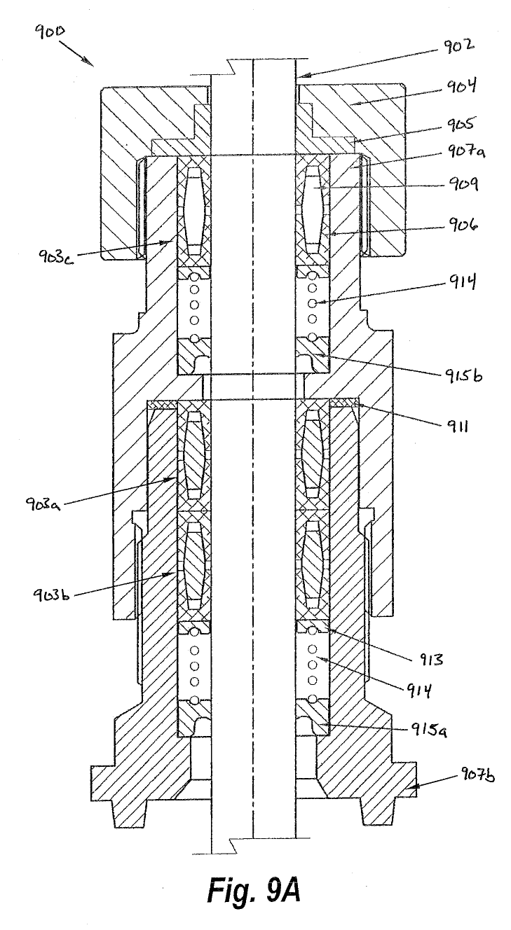

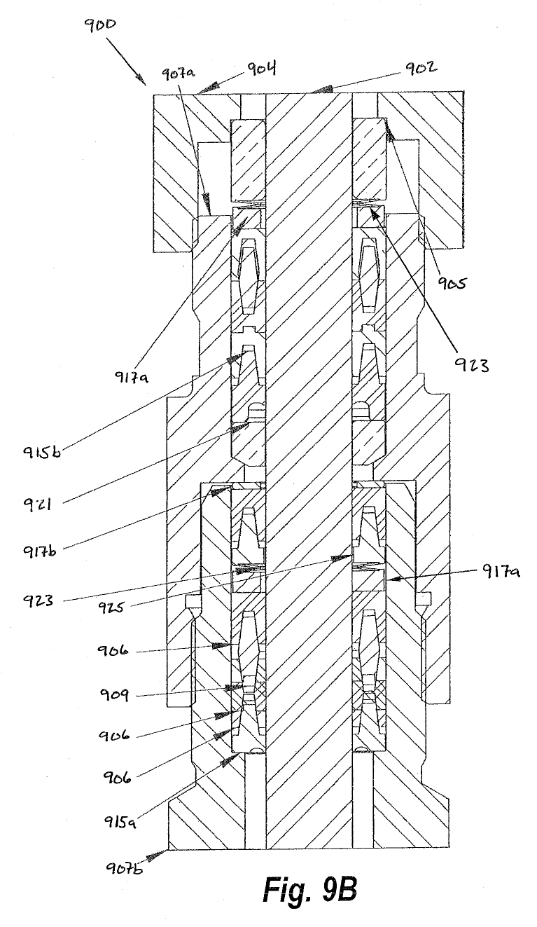

Referring now to FIGS. 9A-11, alternative embodiments of a stuffing box are shown in accordance with additional aspects of the present invention. The apparatus of the alternative embodiments include components functionally similar to that of the device previously described above and shown in FIG. 8, in many respects. Accordingly, where certain features are common to the additional embodiments, such features will not be described in detail in relation to the alternative embodiments wherein those components function in the manner as described above and are hereby incorporated into the alternative embodiments described below.

With reference now to FIG. 9A, an exemplary stuffing box 900 is illustrated in which a body is formed of an upper housing 907a and a lower housing 907b that create a fluid seal around a shaft 902. In some embodiments, a cap 904 is also attached to upper housing 907a and optionally includes a guide bushing 905.

In the illustrated embodiment, one or more seals may be formed within each of upper housing 907a and/or lower housing 907b. For example, a single seal may be formed within upper housing 907a while three fluid seals are formed within lower housing 907b. In particular, a first wedge seal 903a can be positioned at the proximal end of lower housing 907b, and a second wedge seal 903b can be formed below first wedge seal 903b. In addition, a gasket 911 may be placed between upper housing 907a and lower housing 907b, thereby creating a third seal at the lower housing 907b. In addition, a single wedge seal 903c may also be positioned within upper housing 907a to create a fluid seal therein.

Each of the wedge seals 903a-c may be formed of similar or identical components, although it will be appreciated that this is not necessary and that other components may be utilized. For example, in another embodiment one or more of wedge seals 903a-c may be replaced with a wedge packing assembly such as those illustrated in FIG. 8.

In this embodiment, each wedge seal 903a-c includes a tapered wedge 909 which is positioned between shaft 902 and housings 907a-b. Tapered packing 906 is then placed around the tapered wedge 909, such that packing is placed against shaft 902 and housings 907a-b to create a fluid seal. Any suitable wedge may be used. In the illustrated embodiment, for example, wedge 909 is tapered outward towards its middle, such that the thickness of wedge 909 is greater at its middle than at its distal and proximal ends. A wedge seal may, however, also have other shaped wedges. For instance, wedge 925 (FIG. 9B) is tapered upward, such that its thickness at its proximal end is less than its thickness at its distal end. In other embodiments, a wedge may taper downward or may taper inward at its middle.

Packing 906 may be packed around wedge 909 in any desired manner suitable to create a fluid seal. In the illustrated embodiment, for example, wedge 909 is fully supported within tapered packing 909, such that the distal and proximal ends of wedge 909 are enveloped by packing. In other embodiments, the distal and proximal ends of wedge 909 may be supported and compressed by other structural elements, such as guide bushing 905, and platform rings 913.

Wedge seals 903a-c may be secured within housings 907a-b in any suitable manner. For instance, in the illustrated embodiment, platform ring 913 is used to support and compress seals 903a-c. In particular, within lower housing 907b, wedge seal 903a is stacked on top of wedge seal 903b. Wedge seals 903a-b may be directly abutting or, in other embodiments, may have a spacer, such as a washer or gasket, disposed therebetween. Wedge seal 903b may, in turn, rest on a platform ring 913 which is supported by a spring 914 that engages a first scraper 915a.

Similarly, within upper housing 907a, the proximal end of wedge seal 903c can be placed adjacent guide bushing 905 and the distal end of wedge seal 903c can be placed on a platform ring. Consequently wedge seal 903c can be compressed between cap 904 and the platform ring. Additionally, the platform ring may be supported by a spring 914 that engages a second scraper 915b. Thus, in the embodiment illustrated in FIG. 9B, a pair of separate scrapers may each be used to clean debris and/or fluid on the outer surface of shaft 902. This can prevent such removed debris or fluid from degrading seals 903a-c. In addition, removal of the fluid and debris can reduce corrosion or degradation of shaft 902, thereby also prolonging the life of seals 903a-c.

FIG. 9B illustrates the stuffing box 900 of FIG. 9A from a different cross-sectional perspective, and illustrates additional components which may be used within stuffing box 900 to create an effective fluid seal around shaft 902. For instance, in the illustrated embodiment, various washers 917a and bevels 923 may be used as desired. In particular, in the illustrated embodiment, a washer 917a is placed on the proximal surface of the packing above wedge seal 903c (FIG. 9A), between wedge seal 903c and guide bushing 905. To improve the seal, a bevel 923 may also be placed between washer 917a and guide bushing 905. A similar combination of a washer 917a and bevel 923 is found below wedge 925, and between upper wedge seal 903a and lower wedge seal 903b within lower housing 907b. An additional washer 917b may also be placed at the interface between upper housing 907a and lower housing 907b.

As further illustrated in FIG. 9B, and as discussed previously, it can be desirable in some embodiments to have a medial support for shaft 902. Accordingly, in the illustrated embodiment, a bushing 921 is positioned at a medial portion of stuffing box 900. In particular, bushing is positioned below scraper 915b, in this embodiment, and can act as a lip which supports scraper 915b and wedge seal 903c. Although not shown, it will also be appreciated in view of the disclosure herein that stuffing box 900 can include one or more wear indicators. For example, a wear indicator as described herein can be used to indicate to an operator of stuffing box 900 when packing 906 around any of wedge seals 903a-c has deteriorated, thereby providing the operator with an indication that the useful life of the packing is limited and that the operator should soon service or replace the packing.

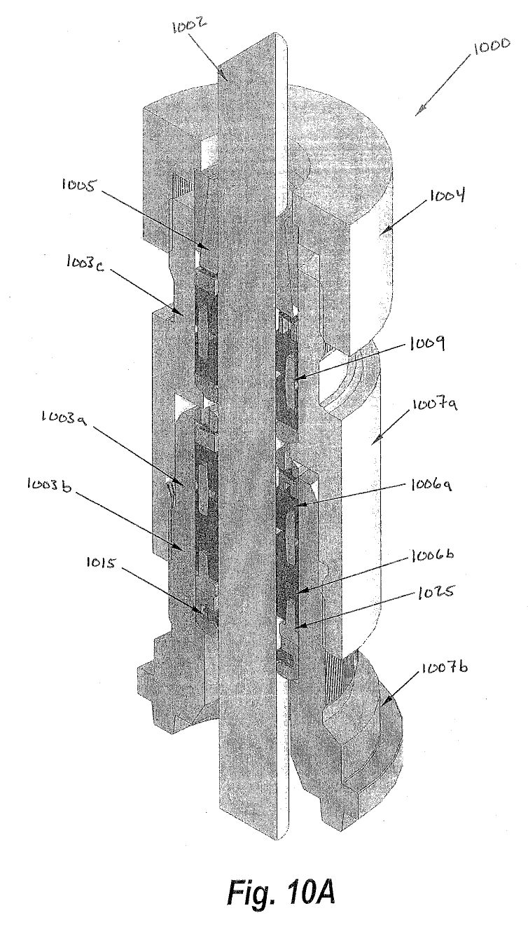

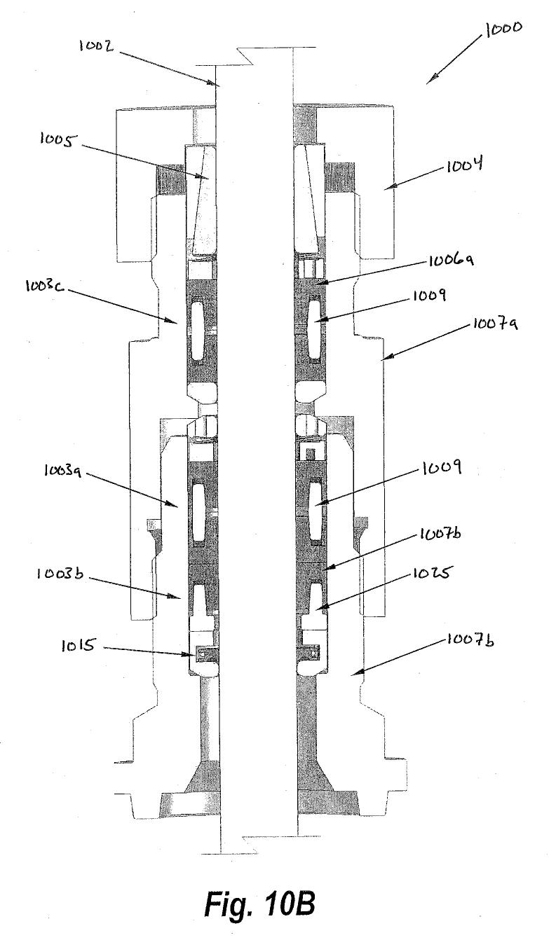

FIGS. 10A-B illustrate additional sectional views of another embodiment of a stuffing box which can be used to seal around a shaft. As illustrated, for example, a stuffing box 1000 seals around a shaft 1002 and can include housing components, including an upper housing 1007a and a lower housing 1007b. In some embodiments, lower housing 1007b is adapted to be connected to a wellhead, but lower housing 1007b can also connect to a variety of other types of strictures. In this embodiment, a cap 1004 is also connected to upper housing 1007a.

A feature of cap 1004 is that it may be removable and thereby allow an operator to easily access stuffing box 1000 to repair or replace components as necessary. In addition, cap 1004 can include an opening therein to receive shaft 1002. In some embodiments, cap 1004 can act as a guide to ensure that shaft 1002 is aligned properly with stuffing box 1000. In other embodiments, however, cap 1004 may not be able to compensate for misalignment.

Accordingly, in the illustrated embodiment, cap 1004 includes a cavity therein for receiving a guide bushing 1005. Guide bushing 1005 can facilitate placement and alignment of shaft 1002 with stuffing box 1000. In the illustrated embodiment, for instance, guide bushing 1005 has a wedge shape to facilitate alignment and compensate for any misalignment between shaft 1002 and stuffing box 1000. In particular, wedge-shaped bushing 1005 is tapered such that the width of bushing 1005 increases from its proximal end to its distal end. In other embodiments, however, other shapes may be used for bushing 1005. For instance, the taper of bushing 1005 can be reversed, or a bushing may not taper. In addition, rather than a straight taper, as illustrated, a taper may be parabolic or may vary in any other suitable manner.

Similar to embodiments described above, stuffing box 1000 can include a plurality of seals 1003a-c useful for creating a fluid seal within stuffing box 1000 and around shaft 1002. For example, in the illustrated embodiment, two seals 1003a-b are created within lower housing 1007b, and a single seal 1003c is formed within upper housing 1007a. Seals 1003a-c can be configured in any manner. For instance, upper seal 1003c may be identical or nearly identical to one or more of lower seals 1003a-b. In the illustrated embodiment, for instance, upper seal 1003c is substantially identical to first lower seal 1003a.

In particular, in the embodiment illustrated in FIGS. 10A-B, seals 1000a and 1000c include a wedge insert 1009 positioned around shaft 1002, and between shaft 1002 and the internal surface of a respective housing 1007a or 1007b. Packing 1006a is also placed around the entire wedge insert 1009, thereby placing packing 1006a between wedge 1009 and shaft 1002, housings 1007a-b, and any guides, washers, platform rings, or springs on which wedge 1009 may be supported.

As best shown in FIG. 10B, wedge 1009 may be tapered. One feature of tapered wedge 1009 is that it facilitates loading of the packing 1006 against shaft 1002, thereby maintaining a fluid seal. In particular, the tapered angle of wedge 1009 causes packing 1006a to press against shaft 1002 to maintain a fluid seal. In the illustrated embodiment, tapered wedge 1009 is tapered outward towards its medial portion. In particular, in the orientation illustrated in FIG. 10B, the width of wedge 1009 increases from its proximal and distal ends towards the middle. Such a taper may be symmetric or asymmetric as desired. In the particular embodiment illustrated, the interior surface of wedge insert 1009 is tapered, while the outer surface of wedge insert 1009 is not tapered. In other embodiments, however, only the outer surface may be tapered, or both the interior and outer surfaces may be tapered.

Tapered wedge 1009 can have any suitable taper angle. For instance, in one embodiment, a tapered surface of tapered wedge 1009 has a taper angle between 3° and 15°. More particularly, the taper angle of wedge 1009 may be between 3° and 8°, and may be about 4° or about 7°.

The illustrated embodiment of stuffing box 1000 also includes a second lower seal 1003b which is different from seals 1003a and 1000c. In the illustrated embodiment, for instance, lower seal 1003b includes a wedge insert 1025 which has a single taper. In particular, wedge 1025 is, in this embodiment, tapered upward, such that the width of wedge 1025 decreases from the distal to the proximal end of wedge 1025. Wedge 1025 can also include, as illustrated, a horizontal platform at its distal end from which the tapered portion extends upward.

In connection with wedge 1025, stuffing box 1000 also includes packing 1006b placed around wedge 1025. The taper on wedge 1025 can facilitate a tight fluid seal of seal 1003b by biasing packing 1006b against shaft 1002. In the illustrated embodiment, packing 1006b is positioned only around the proximal end of wedge 1025, although in other embodiments wedge 1025 may be surrounded by packing.

As noted above, each of seals 1003a-c can be supported by a platform ring, guide, washer, or the like. Moreover, one or more scrapers 1015 can be included within stuffing box 1000. In the illustrated embodiment, scraper 1015 is positioned at a distal end of stuffing box 1000, and in a guide supporting lower seal 1003b. In other embodiments, additional scrapers may be used or a scraper may be positioned elsewhere within stuffing box 1000.

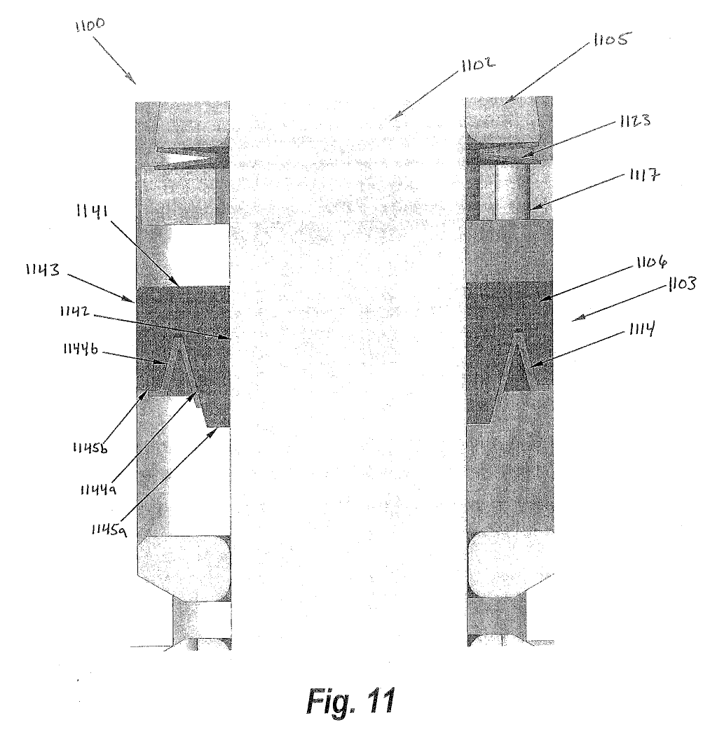

Now turning to FIG. 11, a partial view of an alternative embodiment of a stuffing box is illustrated to further illustrate additional aspects of the present invention. In the illustrated embodiment, a shaft 1102 is positioned within stuffing box , and is guided therein by using a guide bushing 1105. Guide bushing 1105 may be cylindrical or can be wedge shaped, as described herein. When wedge shaped, for example, guide bushing can also act to compensate for misalignment between shaft 1102 and stuffing box .

Guide bushing 1105 can be supported on a housing element of stuffing box as described herein. In addition, or in the alternative, guide bushing 1105 may be placed adjacent, and can be compressed against or supported on a washer 1117. A bevel 1123 may be positioned between washer 1117 and bushing 1105. In some embodiments bevel 1123 is compressible. In the illustrated embodiment, for instance, bevel 1123 has substantially horizontal proximal and distal surfaces which engage the guide bushing 1105 and washer 1123, respectively. Bevel 1123 also tapers inward towards its middle. In particular, in this embodiment, the interior surface of bevel 1123 is substantially straight, while the outer surface of bevel 1123 is tapered inward. Accordingly, the width of bevel 1123 is less at its middle than at either the distal or proximal ends of bevel 1123.

To create a seal around shaft 1102, a seal 1103 may be created. In this embodiment, seal 1103 includes a packing 1106 and an angled plate 1114. In particular, packing 1106 includes an angled cavity having a configuration which generally matches the shape of angled plate 1114. Angled plate 1114 is then embedded within the cavity.

In the illustrated embodiment, for instance, packing 1106 surrounds shaft 1102 and includes a horizontal proximal surface 1142. An interior circumferential surface 1142 defines an opening through which shaft 1102 can be situated, and is compressed against the circumferential surface of shaft 1102. Additionally, an outer circumferential surface 1143 of packing 1103 engages, for example, a housing of stuffing box 1000.

In the illustrated embodiment, the height of internal circumferential surface 1142 is greater than the height of outer circumferential surface 1143. Accordingly, multiple distal surfaces 1145a-b connect circumferential surfaces 1142 and 1143. In particular, in this embodiment, distal surfaces 1145a-b are substantially horizontal and an internal angled surfaces 1144a-b connect horizontal distal surfaces 1145a-b. For instance, in the illustrated embodiment, internal angled surface 1144a extends from interior distal surface 1145a and is angled outward in a proximal direction, toward the housing of stuffing box . Internal angled surface 1144b, in contrast, extends from outer distal surface 1145b, and is angled inward and in a proximal direction, toward shaft 1102. Interior angled surfaces 1144a-b then intersect within packing 1106 to form an inverted V-shaped notch within packing 1106. As noted above, inasmuch as the interior of packing 1106 has a height exceeding the outer height, the arm of the inverted V-shaped notch extends further in a distal direction on the interior of packing 1106.

Angled plate 1114 is configured to fit within the inverted V-shaped notch of packing 1106. For example, in this embodiment, angled plate 1114 also has an inverted V-shape, and engages interior angled surfaces 1144a-b of packing 1106. Additionally, as illustrated in FIG. 11, one or more of the ends of angled plate 1114 can be bent to also engage one or both of distal horizontal surfaces 1145a-b. In the illustrated embodiment, for instance, the outer arm of angled plate 1114 is bent to also engage horizontal surface 1145b.

Angled plate 1114 can be adapted to strengthen packing 1106. Additionally, however, angled plate 1114 can exert a biasing force to compress packing 1106 against the circumferential surface of shaft 1102. In this manner, angled plate 1114 acts as a spring and internally preloads packing 1106. In particular, the biasing force of angled plate 1114 spring-loads packing 1106 and opens the legs of packing 1106 to continually cause packing 1106 to scrape against shaft 1102 and keep a seal therewith. Thus, even as packing 1106 wears down and deteriorates, spring loaded angled plate 1114 can keep opening packing 1106, thereby increasing the size of the inverted V-shaped cavity, and maintain a fluid seal. Moreover, inasmuch as the packing 1106 continues to be biased against shaft 1102, it therefore acts similar to a scraper, but also maintains a seal around shaft 1102.

The invention is susceptible to various modifications and alternative means, and specific examples thereof have been shown by way of example in the drawings and are herein described in detail. It should be understood, however, that the invention is not to be limited to the particular devices or methods disclosed, but to the contrary, the invention is to cover all modifications, equivalents, and alternatives falling within the spirit and scope of the claims.

We claim:

1. A stuffing box, the stuffing box comprising:
at least one seal configured to seal around a circumferential surface of a shaft; and
a wear indicator associated with said at least one seal, said wear indicator being configured to provide an indication of when said at least one seal has deteriorated a predetermined amount.

2. A stuffing box as recited in claim 1, wherein said shaft is a polished rod used in connection with a wellhead.

3. A stuffing box as recited in claim 1, wherein said seal comprises a tapered seal, the stuffing box further comprising:
at least one spring positioned adjacent said tapered seal, wherein said spring is configured to bias said tapered seal against said circumferential surface of said shaft.

4. A stuffing box as recited in claim 1, further comprising:
a guide configured to facilitate insertion of said shaft within the stuffing box and engagement of said circumferential surface of said shaft with said seal.

5. A stuffing box as recited in claim 1, wherein said seal comprises:
packing configured to engage said circumferential surface of said shaft; and
a compression bag compressing said packing against said circumferential surface of said shaft.

6. A stuffing box as recited in claim 1, wherein said at least one seal comprises a first seal and a second seal, said stuffing box further comprising:
a floating plate in contact with a surface of said first seal, wherein said second seal is positioned below said first seal; and
a spring positioned between said floating plate and said second seal, wherein said spring surrounds said first seal and is linked to said first seal, such that said spring is biased to compress said first seal and said second seal against said shaft.

7. A stuffing box as recited in claim 1, wherein said at least one seal comprises:
a spring biased to cause said at least one seal against said circumferential surface of said shaft;
a first tapered guide linked to said spring;
a second tapered guide; and
a wiper seal compressed between said first tapered guide and said second tapered guide.

8. A stuffing box as recited in claim 1, wherein said at least one seal comprises a crown seal compressed between a pair of platform rings, wherein each of said pair of platform rings comprises a spring for biasing said crown seal against said shaft.

9. A stuffing box as recited in claim 1, wherein said at least one sea comprises:
a packing ring engaging the circumferential surface of said shaft, said packing ring defining an angled notch in a distal horizontal surface in said packing ring; and
an angled plate embedded in said angled notch, wherein said angled plate is preloaded to exert a biasing force compressing said packing ring against said circumferential surface of said shaft.

10. A stuffing box, the stuffing box comprising:
a housing, said housing comprising an upper portion and a lower portion, wherein said upper portion is selectively removable from said lower portion;
a first seal within said upper portion of said housing, said first seal comprising:
a first wedge insert; and
first tapered packing, wherein said first wedge insert compresses said first tapered packing against a circumferential surface of a shaft and against an internal surface of said upper portion of said housing; and
a second seal within said lower portion of said housing, said second seal comprising:
a second wedge insert; and
second tapered packing, wherein said second wedge insert compresses said second tapered packing against said circumferential surface of said shaft and against an internal surface of said lower portion of said housing.

11. A stuffing box as recited in claim 10, further comprising:
a tapered bushing within said housing, said tapered bushing being configured to receive said shaft and compensate for any misalignment between said shaft and the stuffing box.
